(19) United States
(12) Patent Application Publication
(10) Pub. No.: US 2026/0366347 A1
(43) Pub. Date: Nov. 19, 2026

(54) DISCHARGE DOOR SYSTEM FOR FIREFIGHTING AIRCRAFT

(71) Applicant: AIRBUS DEFENCE AND SPACE, S.A.U., Madrid (ES)

(72) Inventors: Antonio J. BELTRÁN CUESTA, Sevilla (ES); Ekaitz LUCIO ARRIETA, Tomares, Sevilla (ES)

(21) Appl. No.: 19/137,605

(22) PCT Filed: Dec. 12, 2023
(86) PCT No.: PCT/EP2023/085412

§ 371 Date: Jun. 10, 2025

(30) Foreign Application Priority Data
Dec. 13, 2022 (EP) 22383206.4

(51) Int. Cl. E05C 9/08; B64D 1/16; B65D 90/62; E05D 3/02

(52) U.S. Cl. CPC E05C 9/08; B64D 1/16; B65D 90/623; B65D 2590/542; B65D 2590/666; E05D 3/02

(57) ABSTRACT

For an aerial firefighting aircraft, a mechanical discharge door system for an airborne tank installed inside cargo hold of firefighting aircraft. The airborne tank contains a fluid suitable for firefighting. The discharge door system includes a door hinged to a frame in the tank, a seal along a perimeter of the door, a latch to lock the door closed position wherein the latch includes: latch units configured to lock the door in the closed position from a second side of the frame opposite to the first side where the door hinges; and an actuator in mechanical connection with the plurality of latch units and configured to actuate the latch units to release the door to allow fluid from the tank to be discharged through the frame.

### OBJECT OF THE INVENTION

The present invention relates to the field of aerial firefighting, in particular relates to a mechanical discharge door system for airborne tanks installed inside cargo hold of firefighting aircraft. This airborne tanks containing inside a fluid suitable for firefighting.

### BACKGROUND OF THE INVENTION

In the aeronautical technical field, aerial firefighting makes use of specific aircrafts or helicopters which provides additional resources to combat wildfires.

Specifically, firefighting aircraft bring support to the firefighters on the ground from aircraft in the air which can access steep, rocky, difficult to reach or unsafe areas before ground forces are able to make contact with these areas. Aerial firefighter operations are, at all time, in direct contact with the forces on the ground which provides optimal tactical coordination between all forces. These firefighting aircraft, also referred to as air tankers, carry a volume of fire retardant (fluid), such as water or other chemicals, which are dumped onto designated areas for fire control operations. Fire retardants are known as a mix of chemicals or fluid such as salt compound, water, clay or thickening agent and colouring agent. These types of fire retardants are used to slow down or retard the spread of a target fire. The fire retardant is carried in a tank within the aircraft and is released through the use of a discharge door from the tank.

The release of the fire retardant is a critical operation as it requires a fast-acting operation that ensures the result as well as keeping the tank closed when it is not necessary to release the fire retardant.

The most common current solution to release the fire retardant is a discharge door which is activated remotely and electrically and also actuated with electric/hydraulic power source, which is external to the own aircraft power sources. This solution can be found in several existing firefighter aircraft like the ones equipped with Coulson system, helicopters equipped with aerial fire suppression system, etc.

These known solutions have the disadvantages of requiring to modify the aircraft for providing both electrical and hydraulic power source to the discharge door system. In addition, the electrical and especially hydraulic systems needed for these discharge door systems increase the weight of the overall system in the aircraft, and as a consequence the amount of water to be delivered is reduced. Furthermore, with these solutions the possibility of failure increases in both electrical and hydraulic systems. These electric and hydraulic systems further provides particular maintenance tasks associated to opening/closing equipment's.

Therefore, there is a need in the art for an improved the discharge door systems in the firefighter aircraft avoiding to modify on the aircraft structure for installation and operation, as well as reducing the risk of operational failure.

Document WO2020/014003A1 describes an aerial firefighting dump gate system.

### DESCRIPTION OF THE INVENTION

The present invention provides a solution for the aforementioned problems by a discharge door system according to claim 1, a tank according to claim 14 and a firefighting aircraft according to claim 15. In dependent claims, preferred embodiments of the invention are defined.

A first aspect of the invention provides a discharge door system for a tank, suitable for containing fluid, in a firefighting aircraft, the discharge door system comprising:
a frame configured to be integrated into the tank as an access to the tank;
a door hinged to the frame, in a first side of the frame, by means of a plurality of hinges for opening and closing the door;
sealing means arranged along a perimeter of the door and being configured to fit in the frame when the door is closed; and
a latch mechanism configured for locking the door in a closed position and for releasing the door from the closed position to an opened position when needed, the latch mechanism comprising:
   a plurality of latch units configured to lock the door in the closed position from a second side of the frame opposite to the first side where the door hinges; and
   an actuator in mechanical connection with the plurality of latch units and being configured to actuate the plurality of latch units for releasing the door from the closed position so that the door can be opened and the fluid inside the tank is discharged through the frame.

The present discharge door system has been configured to be integrated in a tank of firefighting aircraft to control the outflow of fluid contained in the tank as needed. In particular, this discharge door system has on the one hand a fixed part which is a frame that can be integrated into the tank as an access to it, and on the other hand a mobile part which is a door hinged on the frame which allows the door to be opened or closed so that the tank access can be opened or closed on whether it is necessary to discharge fluid contained in the tank or not.

Particularly, there are a plurality of hinges through which the door hinges relative to the frame for opening and closing the door. These hinges are located in the lower side of the frame and door so that the door opens in a counterclockwise direction and closes in a clockwise direction.

The door comprises a sealing means located along the perimeter of the door at the edge of the door. This sealing means is configured to fit in the frame when the door is closed. Advantageously, the sealing means ensures fluid tightness of the charge door system.

In addition, there is a latch mechanism provided in the present discharge door system intended to lock the door in a closed position and to release the door to an opened position as needed. Specifically, the latch mechanism comprises a plurality of latch units provided to lock the door in the closed position. This lock is provided from a second side of the frame that is opposite to the first side where the door hinges relative to the frame. That is, the latch units are located in the upper side of the frame. Moreover, the latch mechanism comprises an actuator that is mechanically connected with the plurality of latch units and is configured to actuate them for releasing the door from the closed position to the open position. This latch mechanism is provided with a series of elements that move together mechanically to pass from locking to releasing the door. The latch mechanism is not only configured to lock the door so that it remains closed but is also configured to allow the door to be released so that it can be opened as a result of operating the actuator.

Advantageously, the latch mechanism provides a reliable closing and opening for the discharge door system.

Therefore, the present discharge door system allows the installation and operation of the firefighting equipment with no further modification on the structure, electrical and hydraulic systems in the aerial platform of the aircraft in which the discharge door system has to be installed. Since no additional systems are necessary, as the present discharge door system is purely mechanical and does not require an additional electrical or hydraulic source, the weight in the aircraft is reduced in comparison with the solutions of the prior arts. Furthermore, as the present discharge door system is a mechanical system and does not require any additional hydraulic or electrical source, the possibilities of failure are reduced as well as the maintenance tasks associated to the opening and closing equipment compared to the prior art solutions.

In a particular embodiment, the sealing means is an inflatable seal. In a more particular, the inflatable seal comprises means for inflating and deflating the inflatable seal as needed.

The inflatable seal is provided along the perimeter of the door to ensure the fluid tightness of the discharge door system. In aerial firefighting, the accelerations due to aircraft maneuvering applied to the fluid stored in the tank leads to high loads and deformations on the discharge door system. The inflatable seal provided to the discharge door system the fluid tightness expected in the airborne tank located inside the cargo bay of an aircraft thanks to the capability of the seal to adapt its shape to the relative displacements between foxed parts (frame) and movable parts (door) under those loads.

In another embodiment, the door comprises a groove along the perimeter of the door where the sealing means is partially housed. This groove is provided for the sealing means to be partially allocated.

In a particular embodiment, each hinge comprises:
a hinge fitting attached to the first part of the frame; and
a hinge counter fitting attached to the door and being coordinated with the hinge fitting from the frame so that the hinge counter fitting hinges with respect to the hinge fittings around a door rotating axis for opening and closing the door.

Each hinge is structurally distributed between the frame and the door. A hinge fitting is provided on the first side of the frame, outside the frame and fixed to this first side by means of fasteners. On the other hand, there is a hinge counter fitting that is located on the door, fixed to the door by means of fasteners and also attached to the hinge fittings in a hinge manner. That is, the hinge counter fitting is provided to be coordinate with the hinge fitting for allowing the door to hinge relative to the frame through the rotation the hinge counter fitting performs around a door rotating axis. There is a door rotating axis that is common for all the hinges and it is around this that the hinge counter fittings rotate in the hinge fitting so that the door opens and closes.

In a particular embodiment, the discharge door system comprises three hinges arranged so that the distance between every two adjoining hinges is the same; and/or three latch units arranged so that the distance between every two adjoining units is the same. On this embodiment, the discharge door system is provided with three hinges for hinging the door relative to the frame and three latch units for locking and realizing the door as needed. The provision of three hinges ensures the correct rotation of the door relative to the frame, as well as three latch units ensure a secure locking of the door. In addition, this configuration advantageously provides stability to the discharge door system while keeping the door closed, ensuring its closing and locking function and preventing leakage of the fluid contained in the tank.

In a particular embodiment, each latch unit comprises:
a latch fitting attached on the second side of the frame;
a latch connected to the latch fitting in a hinged manner;
a fitting configured to be attached to the tank;
a first lever connected to the fitting in a hinged manner; and
a rod connecting the latch with the first lever in a hinged manner so that the rod is hinged to the latch and to the first lever.

Each latch unit of the latch mechanism is distributed between the second side of the frame to which part of the latch unit is attached, and a wall of the tank to which the other part of the latch unit is attached, and both parts of the latch unit being mechanically linked each other. In particular, there is a latch fitting fixed on the second side of the frame, outside the frame, and a latch that hinges relative to the latch fitting, so that both latch fitting and latch are mechanically connected as a hinge. There is also a fitting configured to be fixed to the tank and a first lever that hinges relative to the fitting, so that both fitting and first lever are also mechanically connected as a hinge. By last, there is also a rod that connects the latch with the first lever so that the rod hinges relative to the latch and also hinges relative to the first lever.

In a more particular, for each latch unit:
the latch is configured to hinge with respect to the latch fittings around a latch rotating axis;
the first lever is configured to hinge with respect to the fittings around a lever rotating axis; and
the rod is configured to
   hinge with respect to the latch around a first rod rotating axis at a first end of the rod,
   hinge with respect to the first lever around a second rod rotating axis at a second end of the rod opposite to the first end.

There is a latch rotating axis provided through the latch fitting and around which the latch rotates relative to the latch fitting. Additionally, there is a lever rotating axis provided through the fitting and around which the first lever rotates relative to the fitting. By last, there is also a first rod rotating axis and a second rod rotating axis. The first rod rotating axis is provided through the latch and around which the rod at a first end rotates relative to the latch, and the second rod rotation axis is provided through the first lever and around which the rod at a second end, opposite to the first end, rotates relative to the first lever. Specifically, the rod is hinged at both ends and this links the hinged movement of the latch with the hinged movement of the first lever.

In an embodiment, the latch mechanism comprises:
a clamped position wherein, for each latch unit, the latch contacts the door thus keeping the door closed and locked, and the rod and the first lever are arranged so that
   a first line joining the hinge points of the rod and,
   a second line joining the hinge point of the first lever and the hinge point of the rod relative to the first lever,
   form an angle different from 0;
a center position wherein, for each latch unit, the latch remains in contact with the door and, the rod and the first lever are arranged so that the first line and the second line are coincident; and
an unclamped position wherein, for each latch unit, the door ceases to be in contact with the latch as a result of the pressure exerted by the fluid contained in the tank on the door, and the rod and the first lever are arranges so that the first line and the second line form an angle different from 0 thus releasing the door for its opening.

The latch mechanism is configured with at least three positions related to the locking of the door which are a clamped position, a center position and an unclamped position. The clamped position of the latch mechanism corresponds to the closed position of the door in the discharge door system, while the unclamped position corresponds to the opened position of the door. The center position is understood as an intermediate position between the closed position of the door and its opened position. Furthermore, the clamped position is understood as the position where the door is closed and locked, the center position is understood as the position where the door is still closed but unlocked, and the unclamped position is understood as the position where the door is opened.

According to the clamped position and for each latch unit, the latch and the door are in contact since the door is closed and locked with the latch mechanism not being actuated. According to the center position, the latch remains in contact with the door but the door is unlocked since the latch mechanism has been actuated. According to the unclamped position, the door ceases to be in contact with the latch and the door is opened.

Given the configuration of the latch units, and how the rod and the first lever are linked to each other and to the latch and fitting respectively, a relative position has been defined for each position between the rod and the first lever. In both clamped and unclamped positions the rod and first lever are misaligned, whereas in the center position both rod and first lever are aligned. The term “misaligned” is understood as the lines joining the hinge points of the rod and the line joining the hinge point of the first lever and the hinge point of the rod relative to the first lever form between them an angle different from 0. Specifically, there is a first line that joins the hinge point where the rod hinged relative to the first lever and a hinge point where the rod hinges with respect to the latch, and a second line that joins the hinge point where the first lever hinged with respect to the fitting and the hinge point where the rod hinges relative to the first lever. It would be understood that the rod and first lever are misaligned when these first and second lines form an angle different from 0, and that the rod and first lever are aligned when the first and second lines are coincident.

In an embodiment, the actuator comprises:
a cam shaft mechanically connecting the plurality of latch units to each other; and
an actuator handle mechanically connected to the cam shaft;
   wherein the actuator handle is configured to be operated manually by an operator so that when the actuator handle is operated, the cam shaft is moved driving each latch unit for releasing the door from the closed position.

The actuator is configured with an actuator handle and a cam shaft mechanically linked each other. The cam shaft is mechanically connected to the latch units, in particular, like a rod going through the fitting of each latch unit; and is also mechanically connected to the actuator handle. In this sense, when the actuator handle is operated, this involves the movement of the cam shaft which drive the latch units for releasing the door from the closed position. Advantageously, this actuator provides a mechanical operation of the discharge door system which reduces system malfunctions in comparison to the prior art solutions in which the system is operated in remote.

In a particular embodiment, the latch mechanism comprises for each latch unit a second lever solidly linked to the cam shaft so that when the actuator handle is displaced, the cam shaft rotates and the second lever moves the first lever and the rod to the center position.

This second lever is provided for each latch unit and attached to the cam shaft, so that the cam shaft goes through the second lever. When the cam shaft is rotated, as a consequence of the operation of the actuator handle, the second lever pushes the first lever making it move along with the rod from the clamped position to the center position. Then, to move from the center position to the unclamped position, it is the pressure of the fluid contained in the tank on the door itself that will cause the door to open, as the latch units no longer lock the door and the door itself pushes the latch.

Therefore, the present discharge door system operates as follows. First of all it should be noted that the latch units have been configured in such a way that in the closed and locked position of the door the pressure of the fluid on the door keeps the door locked in the closed position, due to the configuration of the latch units in the clamped position with the rod and the first lever misaligned, for each latch unit. In the closed position of the discharge door system, the door remains closed and locked by the latch units. For releasing the door from the closed position (when the latch mechanism is in the clamped position), the actuator handle is operated by displacing it and as a result the cam shaft rotates. When the cam shaft rotates involves that the second lever is moved pushing the first lever. As the first lever is moved (rotating around the lever rotating axis) relative to the fitting, the rod is also move (rotating around the first and second rod rotating axes) relative to the latch and the first lever respectively, thus bringing the latch units into the center position with the rod and the first lever aligned. Once the door is unlocked, i.e., the latch units release the door from the closed position, the fluid contained in the tank presses the door, which causes the door to push the latch. When the door pushes the latch, the latch rotates (around the latch rotating axis) and consequently the rod and the first lever also hinges, so that the unclamped position of the latch mechanism is achieved where the door opens to allow fluid to flow out of the tank.

In an embodiment, the latch mechanism comprises a first safety pin arranged on the actuator handle and being configured to prevent unintended operation of the actuator handle. Advantageously this first safety pin ensures that the actuator handle not being unintended operated, for example as a result of aircraft movements.

In another embodiment, the latch mechanism comprises for each latch unit a second safety pin configured to prevent an unintended aperture of the door. That is, this second safety pin is understood as a pass-through element that partially goes through the fitting to prevent the first lever from rotating relative to the fitting. In order to allow the latch units operate for releasing the door, the second safety pin needs to be removed from each latch unit. Advantageously this second safety pin ensures that the latch units release the door before it becomes necessary.

In a second inventive aspect the invention provides a tank for a firefighting aircraft, the tank comprising a discharge door system according to the first inventive aspect, wherein the frame of the discharge door system is integrated into the tank as an access to the tank.

In a third inventive aspect the invention provides a firefighting aircraft comprising a tank according to the second inventive aspect.

### DESCRIPTION OF THE DRAWINGS

These and other features and advantages of the invention will be more clearly understood based on the following detailed description of a preferred embodiment given only by way of illustrative and non-limiting example in reference to the attached drawings.

FIG. 1 shows a schematic view of a discharge door system according to an embodiment of the present invention

FIG. 2 shows a schematic view of a frame of the discharge door system of FIG. 1.

FIG. 3 shows a schematic view of a door of the discharge door system of FIG. 1.

FIG. 4 shows a schematic view of a latch mechanism of the discharge door system of FIG. 1.

FIGS. 5A-5C show schematic views of a latch mechanism of the discharge door system of FIG. 1 according to different positions.

FIG. 6 shows a schematic cross sectional view of the discharge door system of FIG. 1 in a closed position.

FIG. 7 shows a schematic cross sectional view of the discharge door system of FIG. 1 in an opened position.

FIGS. 8A-8C show schematic representation of a latch mechanism of the discharge door system according to each of its positions.

### DETAILED DESCRIPTION OF THE INVENTION

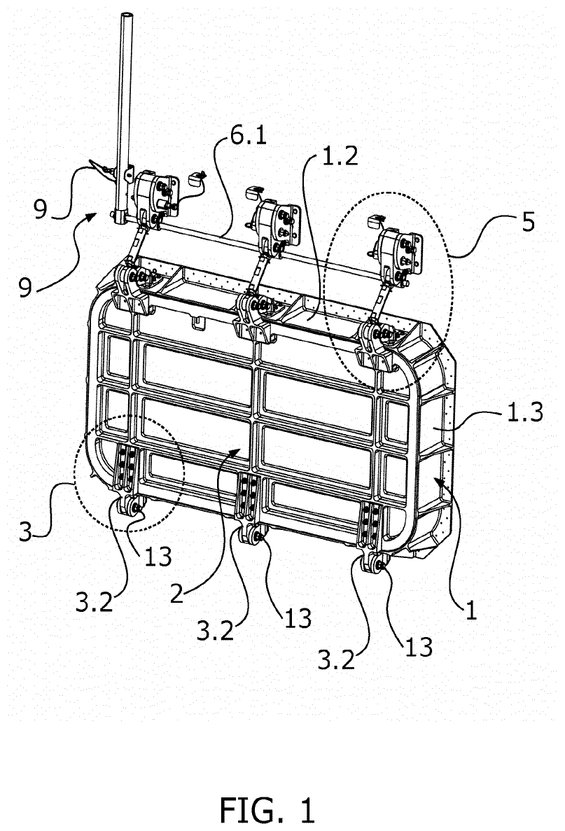

The present invention discloses a discharge door system for a tank in a firefighting aircraft, wherein the tank is suitable for containing a fluid as a fire retardant. In particular, FIG. 1 shows an embodiment of a discharge door system. This discharge door system comprises a frame (1) configured to be integrated into a tank (10) in a firefighting aircraft as an access (12) for the tank (10) through which the fluid is discharged outwards the tank (10).

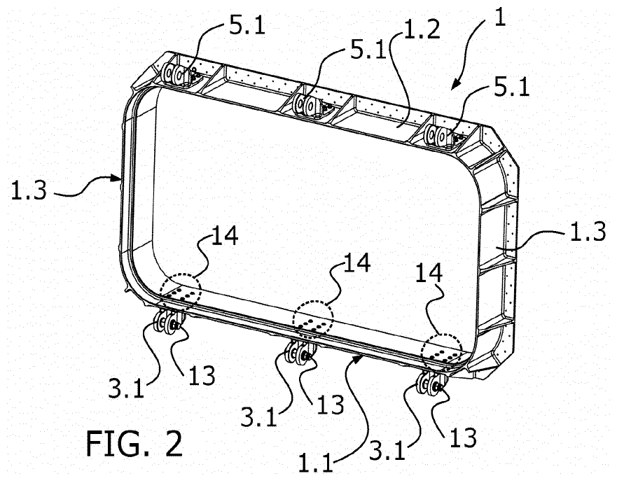

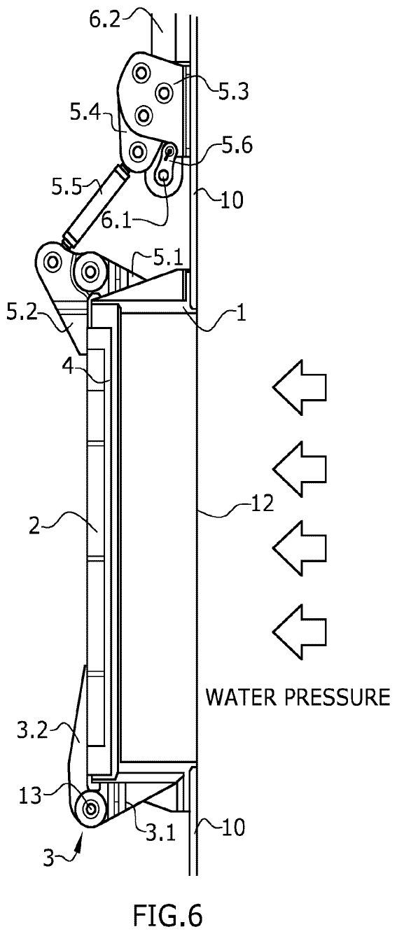

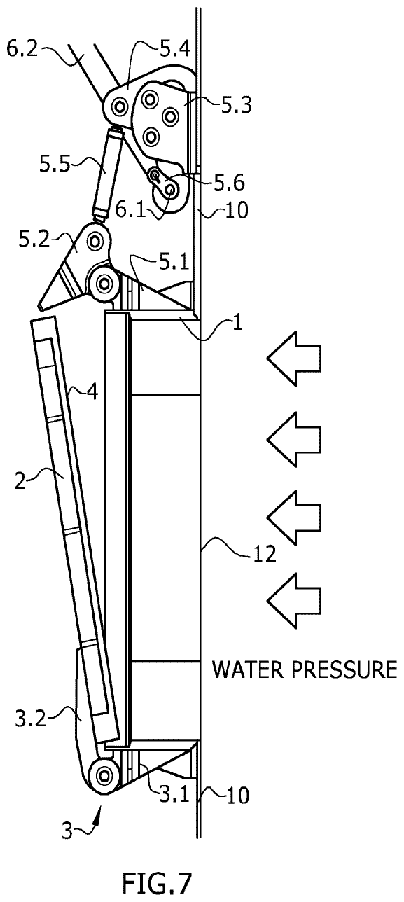

Specifically, FIG. 2 shows a detailed view of the frame (1) of the discharge door system, and this frame (1) comprises a first side (1.1) or lower side and a second side (1.2) or upper side, the first side (1.1) being opposite to the second side (1.2), and the frame (1) further comprises two lateral sides (1.3) also opposite between them and being arranged between the first (1.1) and second (1.2) sides. The frame (1) is suitable to machined and riveted to the tank (10) (shown on FIGS. 6-7).

Returning to FIG. 1, the discharge door system further comprises a door (2) that hinges on the first side (1.1) of the frame (1) by means of three hinges (3) for allowing the opening and closing of the door (2) with respect to the frame (1). This door (2) is shown in detailed in FIG. 2. Moreover, regarding the hinges (3) provided to allow the door (2) to pivot relative to the frame (1), each hinge (3) comprises a hinge fitting (3.1) and a hinge counter fitting (3.2). In a particular example, as shown in FIGS. 1-3, the distance between every two adjoining hinges is the same.

As shown on FIGS. 1 and 2, the hinge fitting (3.1) is fixedly arranged to the first side (1.1) of the frame (1) outside the frame (1). According to this embodiment, the hinge fittings (3.1) are bolted to the first side (1.1) of the frame (1) by a plurality of fasteners (14) per hinge fitting (3.1).

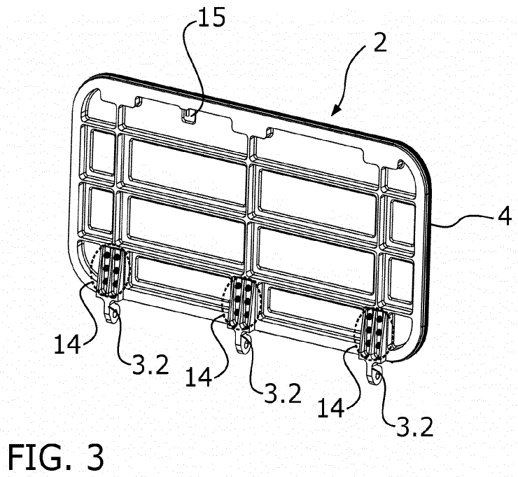

As shown on FIGS. 1 and 3, the hinge counter fitting (3.2) is fixedly arranged to the door (2) in a lower area of the door (2) so that the hinge counter fitting (3.2) is coordinated with the hinge fitting (3.1) of the frame (1) to allow the door (2) to pivot relative to the hinge fitting (3.1) on the frame (1). In particular, the hinge counter fittings (3.2) of the hinges (3) hinges around a door rotating axis (13) for opening and closing the door (2). This door rotating axis (13) is common for all the hinges (3). According to this embodiment, the hinge counter fittings (3.2) are bolted to the door (2) by a plurality of fasteners (14) per hinge counter fitting (3.2).

In an example, the frame (1), door (2) and hinges (3) are made of an aluminum light alloy.

The discharge system shown in FIG. 1 also comprises a sealing means. In particular, as shown on FIG. 3, the sealing means is an inflatable seal (4) located partially within a groove arranged along the perimeter of the door (2) so that this inflatable seal (4) partially fit in the frame (1) when the door (2) is closed. The door (2) has two faces so that one of them is faced towards the inside of the tank (1) and the other is opposite to it, so that the hinge counter fittings (3.2) are arranged at one side of the door (2) and the inflatable seal (4) is arranged at the opposite side of the door (2). Furthermore, the inflatable seal (4) comprises a valve for inflating and deflating the inflatable seal (4) as needed; and the door (2) comprises a housing (15) for the valve in contact with the inflatable seal (4).

In an example, the inflatable seal (4) is made of silicone rubber and the valve is configured with captive jam nut.

Following with FIG. 1, the discharge door system also comprises a latch mechanism for locking the door (2) in a closed position covering the access (12) of the tank (10) through the frame (1) and, for releasing the door (2) from the closed position to an opened position where the door (2) is opened and the fluid inside the tank (10) can be discharged through the frame (1) outwards the tank (10). The latch mechanism comprises three latch units (5), all of them the same, for locking the door (2) in the closed position from the second side (1.2) of the frame (1). In this embodiment, the distance between every two adjoining latch units (5) is the same.

The latch mechanism shown on FIG. 1 also comprises an actuator (6) that is mechanically connected with the three latch units (5) for actuating them in order to release the door (2) from the closed position to the opened position. Specifically, FIG. 1 shows the discharge door system in a closed position where the door (2) closes the access (12) to the tank (10) covering the frame (1).

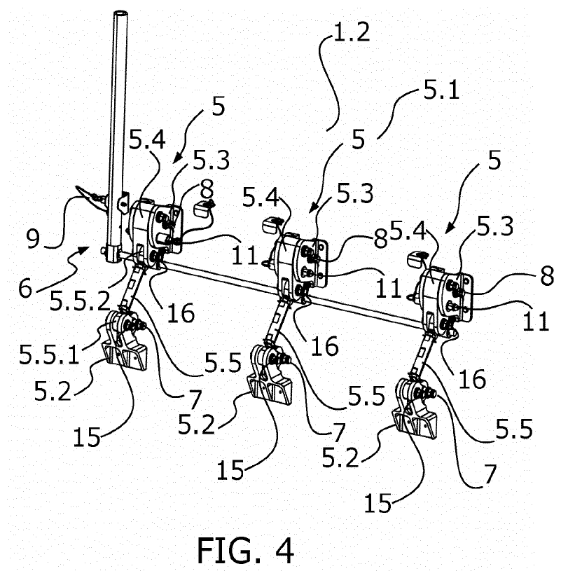

FIG. 4 shows in detail the latch mechanism of the discharge door system already disclosed above. The latch units (5) are configured to be attached to the frame (1) on one side and to the tank (10) on the other side. More particularly, each latch unit (5), of the three shown in this embodiment of FIG. 4, comprises a latch fitting (5.1) fixed to the second side (1.2) of the frame (1) outside the frame (1) (as shown in FIG. 1), and a fitting (5.3) configured to be fixed to the tank (10) (as shown on FIGS. 6 and 7). In addition, each latch unit (5) comprises a latch (5.2) that hinges around a door rotating axis (7) relative to the latch fitting (5.1), and a first lever (5.4) that hinges around a lever rotating axis (8) relative to the fitting (5.3). The door rotating axis (7) is common for all the latch units (5) and the lever rotating axis (8) is common for all the latch units (5). By last, there is a rod (5.5) that connects the latch (5.2) with the first lever (5.4). In this sense, at a first end (5.5.1) of the rod (5.5), the rod (5.5) hinges around a first rod rotating axis (15) relative to the latch (5.2); and at a second end (5.5.2) of the rod (5) that is opposite to the first end (5.5.1), the rod (5.5) hinges around a second rod rotating axis (16) relative to the first lever (5.4).

In addition, FIG. 4 shows that the latch mechanism further comprises an actuator (6). This actuator (6) comprises a cam shaft (6.1) that mechanically connects the three latch units (5) to each other and an actuator handle (6.2) that is connected at one of its ends to the cam shaft (6.1). This actuator handle (6.2) is provided to be operated manually by an operator from the inside of the aircraft. When the actuator handle (6.2) is operated this actuation is transmitted as a movement to the cam shaft (6.1) which in turn drives each latch unit (5) at the same time for releasing the door (2) from the closed position. To operate the actuator (6), a displacement movement is applied to the actuator handle (6.2) so that the displacement of the actuator handle (6.2) causes the rotation of the cam shaft (2.1). In particular, the latch mechanism shown in FIG. 4 is in the closed position of the discharge door system, that is, when the actuator (6) has not yet been operated.

The latch mechanism also comprises for each latch unit (5) a second lever (5.6) that is solidly linked with the cam shaft (6.1) so that when the cam shaft (6.1) rotates as a consequence of the displacement of the actuator handle (6.2), the second lever (5.6) also rotates moving the first lever (5.4) and the rod (5.5).

Moreover, FIG. 4 shows that the latch mechanism also comprises a first safety pin (9) arranged on the actuator handle (6.2) of the actuator (6) for preventing the actuator handle (6.2) to be unintended operated. In addition, each latch unit (5) comprises a second safety pin (11) for preventing the door (2) to be unintended opened.

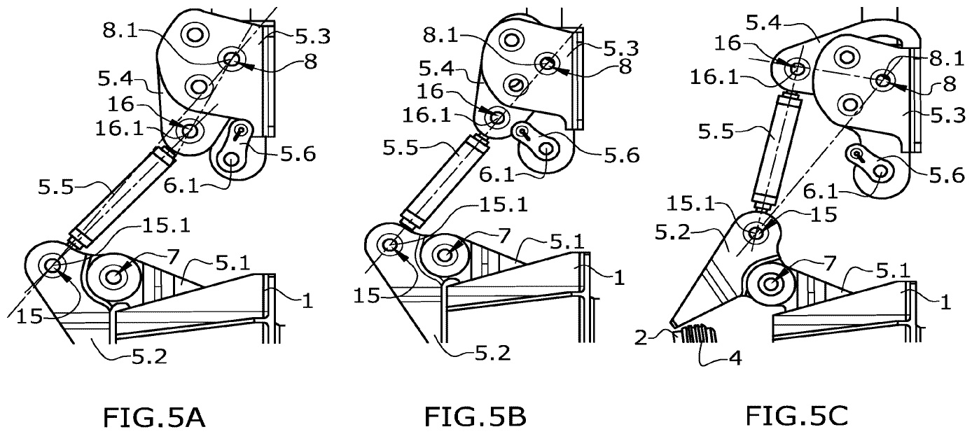

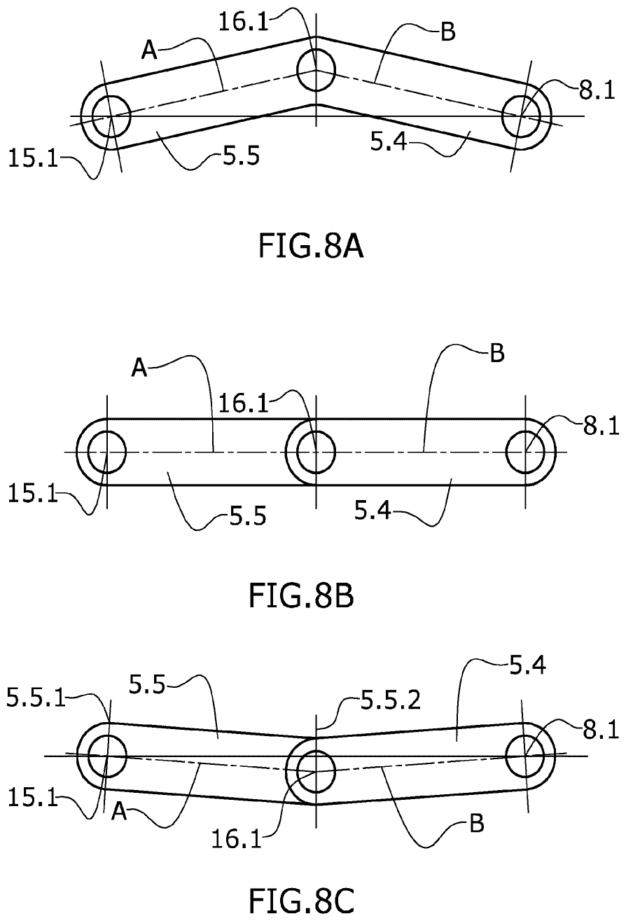

FIGS. 5A-5C show different positions of the latch mechanism according to a sectional view of the discharge door system already described above. Furthermore, FIGS. 8A-8C show the relative position of the rod (5.5) and the first lever (5.4) to each other according to the position shown in FIGS. 5A-5C respectively and regarding the hinge point of both rod (5.5) and first lever (5.4).

FIG. 5A discloses a clamped position of the latch mechanism that corresponds to the position where the door (2) is closed and locked. According to this clamped position, the latch (5.2) and the door (2) are in contact pressing on each other and the rod (5.5) and the first lever (5.4) are misaligned (also shown on FIG. 8C) according to their respective hinge points. Specifically, and for a better understanding of the term “misaligned”, there is a first line (A) that joins a hinge point (15.1) of the first rod rotating axis (15) where the rod (5.5) hinges relative to the latch (5.2) with a hinge point (16.1) of the second rotating axis (16) wherein the rod 85.5) hinges relative to the first lever (5.4). Further, there is a second line (B) that joins a hinge point (8.1) of the lever rotating axis (8) where the first lever (5.4) hinges relative to the fitting (5.3) with the hinge point (16.1) of the second rod rotating axis (16). As it can be observed in FIG. 8C, the first (A) and second (B) lines form an angle different from 0 which means that the hinge points of both rod (5.5) and first lever (5.4) are not aligned.

FIG. 5B discloses a center position of the latch mechanism that corresponds to the position where the door (2) is unlocked but is still in contact with the latch (5.2). The center position is understood as an intermediate position between the open and closed position of the door (2). In this center position, the latch mechanism does not block the door (2) but the door (2) has not yet opened. In this center position the hinge points of both rod (5.5) and first lever (5.4) are aligned. This means that the first line (A) and the second line (B) are coincident as it can be observed in detail in FIG. 8B.

FIG. 5C discloses an unclamped position of the latch mechanism that corresponds to the position where the latch (5.2) ceases to contact with the door (2) and the door (2) is opened. The unclamped position is achieved once the latch mechanism ceases to lock the door (2) and the fluid contained in the tank (10) presses the door (2) to open it with the aim the fluid to be discharged outwards the tank (10). According to this unclamped position, the hinge points of the rod (5.5) and the first lever (5.4) are also misaligned as it can be observed in FIG. 8A. The difference between FIG. 5A and FIG. 5C is that in order to get into the unclamped position the second lever (5.6) has been turned (as a consequence of the actuator (6) to be actuated) by pushing the first lever (5.4) into the unclamped position shown in FIG. 5c. In particular, the angle that form the lines (A, B) in the clamped position is different from the angle that form the lines (A, B) in the unclamped position.

FIG. 6 shows a cross sectional view of the discharge door system integrated in a tank (10) with the latch mechanism in the clamped position and the door (2) closed and clocked. Given the configuration of the latch mechanism in the clamped position, the pressure exerted on the door (2) by the fluid contained in the tank (10) makes the latch (5.2) to be self-locked under this pressure. In this example, the fluid contained in the tank (10) is water and the pressure exerted by the water on the door (2) is shown by arrows.

FIG. 7 shows a cross sectional view of the same discharge door system as in FIG. 6 with the latch mechanism in the unclamped position and the door (2) partially opened. When the actuator (6) is operated, by displacing the actuator handle (6.2) causing the rotation of the cam shaft (6.1), the second lever (5.6) rotates, pushing the first lever (5.4), i.e. making the first lever (5.4) rotate relative to the fitting (5.3), which releases the latch (5.2) locking the door (2) and the force exerted by the fluid on the door (2) causes the door (2) to open. This figure also shows by arrows the pressure exerted by the water contained in the tank (10) on the door (2).

1. A discharge door system for a tank configured to contain a firefighting fluid, in a firefighting aircraft, the discharge door system comprising:
a frame configured to be integrated into the tank as an access to the tank;
a door hinged to the frame, in a first side of the frame, by a plurality of hinges for opening and closing the door;
a seal arranged along a perimeter of the door and configured to fit in the frame when the door is closed; and
a latch mechanism configured to lock the door in a closed position and to release the door from the closed position to an opened position,
wherein the latch mechanism includes:
a plurality of latch units configured to lock the door in the closed position from a second side of the frame opposite to the first side of the door; and
an actuator in mechanical connection with the plurality of latch units and configured to actuate the plurality of latch units to release the door and allow the door to move from the closed position to an open position and to allow the firefighting fluid in the tank to flow through the frame.

2. The discharge door system according to claim 1, wherein the seal is an inflatable seal.

3. The discharge door system according to claim 2, wherein the inflatable seal comprises means for inflating and deflating the inflatable seal.

4. The discharge door system according to claim 1, wherein the door comprises a groove along the perimeter of the door where the seal is partially housed.

5. The discharge door system according to claim 1, wherein each of the plurality of hinges comprises:
a hinge fitting attached to the first side of the frame; and
a hinge counter fitting attached to the door and being coordinated with the hinge fitting from the frame so that the hinge counter fitting hinges with respect to the hinge fittings around a door rotating axis for opening and closing the door.

6. The discharge door system according to claim 1, wherein the plurality of hinges includes at least three hinges arranged so that a distance is uniform between adjacent pairs of the hinges.

7. The discharge door system according to claim 1, wherein each latch unit comprises:
a latch fitting attached on the second side of the frame;
a latch connected to the latch fitting in a hinged manner;
a fitting configured to be attached to the tank;
a first lever connected to the fitting in a hinged manner; and
a rod connecting the latch with the first lever in a hinged manner so that the rod is hinged to the latch and to the first lever.

8. The discharge door system according to claim 7, wherein for each of the latch units:
the latch is configured to hinge with respect to the latch fittings around a latch rotating axis; and
the first lever is configured to hinge with respect to the fittings around a lever rotating axis; and
the rod is configured to:
hinge with respect to the latch around a first rod rotating axis at a first end of the rod, and
hinge with respect to the first lever around a second rod rotating axis at a second end of the rod opposite to the first end.

9. The discharge door system according to claim 7, wherein the latch mechanism comprises:
a clamped position wherein, for each of the latch units, the latch contacts the door to keep the door closed and locked, and the rod and the first lever are arranged so that:
a first line joining the hinge points of the rod, and,
a second line joining the hinge point of the first lever and the hinge point of the rod relative to the first lever,
form an angle different from zero;
a center position wherein, for each latch unit, the latch remains in contact with the door and, the rod and the first lever are arranged so that the first line and the second line are coincident; and
an unclamped position wherein, for each of the latch units, the door ceases to be in contact with the latch as a result of the pressure exerted by the fluid contained in the tank on the door, and the rod and the first lever are arranges so that the first line and the second line (B) form an angle different from 0 thus releasing the door to open.

10. The discharge door system according to claim 1, wherein the actuator comprises:
a cam shaft mechanically connecting the plurality of latch units to each other; and
an actuator handle mechanically connected to the cam shaft;
wherein the actuator handle is configured to be operated manually by an operator so that when the actuator handle is operated, the cam shaft is moved driving each latch unit for releasing the door from the closed position.

11. The discharge door system according to claim 9, wherein the latch mechanism comprises for each of the latch units, a second lever solidly linked to the cam shaft so that when the actuator handle is displaced, the cam shaft rotates and the second lever moves the first lever and the rod to the center position.

12. The discharge door system according to claim 10, wherein the latch mechanism comprises a first safety pin arranged on the actuator handle and configured to prevent unintended operation of the actuator handle.

13. The discharge door system according to claim 1, wherein the latch mechanism further comprises for each of the latch units, a second safety pin configured to prevent an unintended opening of the door.

14. A tank for a firefighting aircraft, the tank comprising a discharge door system according to claim 1.

15. A firefighting aircraft comprising the tank according to claim 1.
